(19) United States
(12) Patent Application Publication
(10) Pub. No.: US 2019/0166572 A1
(43) Pub. Date: May 30, 2019

(54) SYNCHRONIZATION TECHNIQUES FOR NEIGHBORHOOD AWARENESS NETWORK DEVICE LINKS

(71) Applicant: QUALCOMM Incorporated, San Diego, CA (US)

(72) Inventors: Santosh Paul Abraham, San Diego, CA (US); Abhishek Pramod Patil, San Diego, CA (US); Alireza Raissinia, Monte Sereno, CA (US); Shivraj Singh Sandhu, Milpitas, CA (US)

(21) Appl. No.: 16/203,225

(22) Filed: Nov. 28, 2018

Related U.S. Application Data
(60) Provisional application No. 62/592,346, filed on Nov. 29, 2017.

(51) Int. Cl. H04W 56/00; H04W 24/08; H04W 8/00; H04W 48/16; H04L 12/26

(52) U.S. Cl. CPC H04W 56/0015; H04W 56/003; H04W 24/08; H04W 84/12; H04W 48/16; H04L 43/16; H04W 8/005

(57) ABSTRACT

Methods, systems, and devices for wireless communication are described. Stations within a neighborhood awareness network (NAN) may determine when to transmit synchronization beacons during a wake-up time based on some priority (e.g., stations with more recent clock updates or earlier time stamps, stations communicating with a larger number of peers or associated with a larger number of NAN device links (NDLs), etc. may transmit beacons earlier in a wake-up window or with a higher probability). Other stations within the NAN may maintain clock synchronization based on the transmitted beacons (e.g., that include recently updated clock information). Additionally or alternatively, a station may signal other stations within a NAN when the station detects disappearance of synchronization beacons (e.g., or loss of clock synchronization). In some cases, the signaling may include requests for the one or more other stations to start or stop beacon transmissions as desired.

### CROSS REFERENCES

The present Application for Patent claims the benefit of U.S. Provisional Patent Application No. 62/592,346 by ABRAHAM, et al., entitled “SYNCHRONIZATION TECHNIQUES FOR NEIGHBORHOOD AWARENESS NETWORK DEVICE LINKS,” filed Nov. 29, 2017, assigned to the assignee hereof, and expressly incorporated herein.

### BACKGROUND

The following relates generally to wireless communication, and more specifically to synchronization techniques for neighbor awareness network (NAN) device links (NDLs).

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the station, and the uplink (or reverse link) may refer to the communication link from the station to the AP.

STAs may communicate directly via a wireless mesh or peer-to-peer (P2P) network where STAs may form a network without a base station, APs, or other equipment. In some examples, a P2P network may refer to a NAN (e.g., a wireless communications system may operate according to a NAN communication protocol). Wireless devices in a NAN (e.g., NAN devices) may share a common set of parameters (e.g., a time duration of discovery windows, a beacon interval, NAN discovery channel(s), etc.). NAN devices may use such information to discover other NAN devices, establish NDLs with other NAN devices, determine NAN Master and NAN Non-Master roles, etc. In some cases (e.g., when a NAN Master or parent device moves out of the network, when a beacon or discovery window is missed, etc.), a NAN device may lose clock synchronization with the NAN. Such loss of clock synchronization may result in loss of discovery window and or base schedule timing, NDL failures, etc. which may degrade system performance. Improved synchronization techniques for NAN devices may thus be desired.

### SUMMARY

The following relates to improved methods, systems, devices, or apparatuses that support synchronization techniques for neighbor awareness network (NAN) device links (NDLs). Stations within a NAN may determine when to transmit synchronization beacons (e.g., clock information) during a window or wake-up time based on some priority. That is, stations with more recent clock updates (e.g., earlier time stamps), stations communicating with a larger number of peers (e.g., associated with a larger number of NDLs), etc. may transmit beacons earlier in a wake-up window or with a higher probability. For example, a station may determine a hypothetical beacon transmission time (e.g., determine a future contention window (CW) time period) or a wait time duration (e.g., a time duration from the beginning of some wake-up time) for transmission of a beacon during some wake-up time. The wake-up time may be defined according to a NAN discovery window schedule and/or a NAN data cluster (NDC) base schedule.

For example, a hypothetical transmission time or wait time duration may be determined based on a time duration since clock synchronization information was last received by the station. In other examples, a probabilistic transmission parameter (e.g., transmission probability) may be determined based on a number of NDLs associated with the station. In yet other examples, the station may determine a number of time blocks (TBs) since a previous beacon transmission from the station (e.g., the number of TBs since the station was last able to advertise), which may also be used to determine when the station may transmit a beacon during the NDC wake-up time (e.g., the station may transmit a beacon after x TBs have passed without the station having transmitted a beacon).

A station may transmit beacons (e.g., that include clock information associated with the respective station) after the determined wait time and/or according to the determined transmission probability. Other stations within the NAN may maintain clock synchronization based on the transmitted beacons (e.g., beacons may include more recently updated clock information, or clock information associated with an earlier time stamp). Additionally or alternatively, a station may signal (e.g., via a NAN management frame (NMF)) other stations within the NAN when the station detects disappearance of synchronization beacons (e.g., loss of clock synchronization). In some cases, the signaling may include requests for the one or more other stations to start or stop beacon transmissions as desired.

A method of wireless communication is described. The method may include monitoring a wireless channel of an NDC at a scheduled wake-up time associated with the NDC. The method may further include determining, based at least in part on the monitoring, that a threshold number of beacons including an earlier time stamp than a time stamp of the station has not been received at a power level above a threshold power level over the channel during the scheduled wake-up time. The method may yet further include transmitting a beacon including clock synchronization information and the time stamp of the station over at least one NDL during the scheduled wake-up time based at least in part on the determining.

A wireless device for wireless communication is described. The wireless device may include a wireless modem. The wireless modem may be configured to perform a monitoring procedure of a wireless channel of an NDC at a scheduled wake-up time associated with the NDC, and determine, based at least in part on the monitoring, that a threshold number of beacons including an earlier time stamp than a time stamp of the station has not been received at a power level above a threshold power level over the channel during the scheduled wake-up time. The wireless modem may be further configured to provide for transmission, a beacon including clock synchronization information and the time stamp of the station over at least one NDL during the scheduled wake-up time based at least in part on the determining.

An apparatus for wireless communication is described. The apparatus may include means for monitoring a wireless channel of an NDC at a scheduled wake-up time associated with the NDC. The apparatus may further include means for determining, based at least in part on the monitoring, that a threshold number of beacons including an earlier time stamp than a time stamp of the station has not been received at a power level above a threshold power level over the channel during the scheduled wake-up time. The apparatus may yet further include means for transmitting a beacon including clock synchronization information and the time stamp of the station over at least one NDL during the scheduled wake-up time based at least in part on the determining.

Another apparatus for wireless communication is described. The apparatus may include a processor, memory in electronic communication with the processor, and instructions stored in the memory. The instructions may be operable to cause the processor to monitor a wireless channel of an NDC at a scheduled wake-up time associated with the NDC, and determine, based at least in part on the monitoring, that a threshold number of beacons including an earlier time stamp than a time stamp of the station has not been received at a power level above a threshold power level over the channel during the scheduled wake-up time. The instructions may be further operable to transmit a beacon including clock synchronization information and the time stamp of the station over at least one NDL during the scheduled wake-up time based at least in part on the determining.

A non-transitory computer-readable medium for wireless communication is described. The non-transitory computer-readable medium may include instructions operable to cause a processor to monitor a wireless channel of an NDC at a scheduled wake-up time associated with the NDC, and determine, based at least in part on the monitoring, that a threshold number of beacons including an earlier time stamp than a time stamp of the station has not been received at a power level above a threshold power level over the channel during the scheduled wake-up time. The non-transitory computer readable medium may further include instructions operable to cause a processor to transmit a beacon including clock synchronization information and the time stamp of the station over at least one NDL during the scheduled wake-up time based at least in part on the determining.

Some examples of the method, wireless device, apparatus, and non-transitory computer-readable medium described above may further include processes, features, means, or instructions for receiving a second beacon including an earlier time stamp than the time stamp of the station. Some examples of the method, apparatus, and non-transitory computer-readable medium described above may further include processes, features, means, or instructions for suspending beacon transmissions by the station based at least in part on the received second beacon.

Some examples of the method, wireless device, apparatus, and non-transitory computer-readable medium described above may further include processes, features, means, or instructions for receiving, from second station, the clock synchronization information during a NAN discovery window (DW). Some examples of the method, apparatus, and non-transitory computer-readable medium described above may further include processes, features, means, or instructions for determining a wait time duration from the scheduled wake-up time, where the wait time duration may be determined based at least in part on a time duration since the clock synchronization information was received. Some examples of the method, apparatus, and non-transitory computer-readable medium described above may further include processes, features, means, or instructions for transmitting the beacon including clock synchronization information and the time stamp of the station after the determined wait time.

Some examples of the method, wireless device, apparatus, and non-transitory computer-readable medium described above may further include processes, features, means, or instructions for determining a probabilistic transmission parameter based at least in part on a number of NDLs associated with the station. Some examples of the method, apparatus, and non-transitory computer-readable medium described above may further include processes, features, means, or instructions for transmitting the beacon including clock synchronization information and the time stamp of the station according to the determined probabilistic transmission parameter.

Some examples of the method, wireless device, apparatus, and non-transitory computer-readable medium described above may further include processes, features, means, or instructions for determining a number of TBs since a previous beacon transmission from the station. Some examples of the method, apparatus, and non-transitory computer-readable medium described above may further include processes, features, means, or instructions for transmitting the beacon including clock synchronization information and the time stamp of the station based at least in part on the determination. In some examples of the method, apparatus, and non-transitory computer-readable medium described above, the threshold number of beacons may be one beacon. In some examples of the method, apparatus, and non-transitory computer-readable medium described above, the threshold power level may be based at least in part on a minimum power level for reception.

Some examples of the method, wireless device, apparatus, and non-transitory computer-readable medium described above may further include processes, features, means, or instructions for identifying that no beacons have been received based at least in part on the power level indicating no-power or an absence of any measurable power and determining to switch from the monitoring based at least in part on the identification, wherein the beacon is transmitted based at least in part on the determination.

A method of wireless communication is described. The method may include monitoring a wireless channel of an NDC at a scheduled wake-up time associated with the NDC, and determining, based at least in part on the monitoring, that a threshold number of beacons including an earlier time stamp than a time stamp of the station has not been received at a power level above a threshold power level over the channel during the scheduled wake-up time. The method may further include transmitting a beacon including clock synchronization information and the time stamp of the station over at least one NDL during the scheduled wake-up time based at least in part on the determining, where the beacon includes paging attributes for one or more of the at least one NDLs and determining a number of TBs since a previous beacon transmission from the station. The method may further include transmitting a paging message during one of the one or more TBs, where the time stamp of the station is carried in the paging message.

An apparatus for wireless communication is described. The apparatus may include means for monitoring a wireless channel of an NDC at a scheduled wake-up time associated with the NDC, and means for determining, based at least in part on the monitoring, that a threshold number of beacons including an earlier time stamp than a time stamp of the station has not been received at a power level above a threshold power level over the channel during the scheduled wake-up time. The apparatus may further include means for transmitting a beacon including clock synchronization information and the time stamp of the station over at least one NDL during the scheduled wake-up time based at least in part on the determining, where the beacon includes paging attributes for one or more of the at least one NDLs, means for determining a number of TBs since a previous beacon transmission from the station, and means for transmitting a paging message during one of the one or more TBs, where the time stamp of the station is carried in the paging message.

Another apparatus for wireless communication is described. The apparatus may include a processor, memory in electronic communication with the processor, and instructions stored in the memory. The instructions may be operable to cause the processor to monitor a wireless channel of an NDC at a scheduled wake-up time associated with the NDC, determine, based at least in part on the monitoring, that a threshold number of beacons including an earlier time stamp than a time stamp of the station has not been received at a power level above a threshold power level over the channel during the scheduled wake-up time, and transmit a beacon including clock synchronization information and the time stamp of the station over at least one NDL during the scheduled wake-up time based at least in part on the determining, where the beacon includes paging attributes for one or more of the at least one NDLs. The instructions may further be operable to determine a number of TBs since a previous beacon transmission from the station, and transmit a paging message during one of the one or more TBs, where the time stamp of the station is carried in the paging message.

A non-transitory computer-readable medium for wireless communication is described. The non-transitory computer-readable medium may include instructions operable to cause a processor to monitor a wireless channel of an NDC at a scheduled wake-up time associated with the NDC, determine, based at least in part on the monitoring, that a threshold number of beacons including an earlier time stamp than a time stamp of the station has not been received at a power level above a threshold power level over the channel during the scheduled wake-up time, and transmit a beacon including clock synchronization information and the time stamp of the station over at least one NDL during the scheduled wake-up time based at least in part on the determining, where the beacon includes paging attributes for one or more of the at least one NDLs. The non-transitory computer-readable medium may further include instructions operable to cause a processor to determine a number of TBs since a previous beacon transmission from the station, and transmit a paging message during one of the one or more TBs, where the time stamp of the station is carried in the paging message.

A method of wireless communication is described. The method may include monitoring a wireless channel of an NDC at a scheduled wake-up time associated with the NDC, determining, based at least in part on the monitoring, that a threshold number of beacons including an earlier time stamp than a time stamp of the station has not been received at a power level above a threshold power level over the channel during the scheduled wake-up time, identifying a NAN DW for transmission of a beacon including clock synchronization information and the time stamp of the station based at least in part on the determining, and transmitting the beacon including clock synchronization information and the time stamp of the station over at least one NDL during the identified NAN DW, where the beacon includes paging attributes for one or more of the at least one NDLs.

An apparatus for wireless communication is described. The apparatus may include means for monitoring a wireless channel of an NDC at a scheduled wake-up time associated with the NDC, and means for determining, based at least in part on the monitoring, that a threshold number of beacons including an earlier time stamp than a time stamp of the station has not been received at a power level above a threshold power level over the channel during the scheduled wake-up time. The apparatus may further include means for identifying a NAN DW for transmission of a beacon including clock synchronization information and the time stamp of the station based at least in part on the determining, and means for transmitting the beacon including clock synchronization information and the time stamp of the station over at least one NDL during the identified NAN DW, where the beacon includes paging attributes for one or more of the at least one NDLs.

Another apparatus for wireless communication is described. The apparatus may include a processor, memory in electronic communication with the processor, and instructions stored in the memory. The instructions may be operable to cause the processor to monitor a wireless channel of an NDC at a scheduled wake-up time associated with the NDC, and determine, based at least in part on the monitoring, that a threshold number of beacons including an earlier time stamp than a time stamp of the station has not been received at a power level above a threshold power level over the channel during the scheduled wake-up time. The instructions may further be operable to cause the processor to identify a NAN DW for transmission of a beacon including clock synchronization information and the time stamp of the station based at least in part on the determining, and transmit the beacon including clock synchronization information and the time stamp of the station over at least one NDL during the identified NAN DW, where the beacon includes paging attributes for one or more of the at least one NDLs.

A non-transitory computer-readable medium for wireless communication is described. The non-transitory computer-readable medium may include instructions operable to cause a processor to monitor a wireless channel of an NDC at a scheduled wake-up time associated with the NDC, and determine, based at least in part on the monitoring, that a threshold number of beacons including an earlier time stamp than a time stamp of the station has not been received at a power level above a threshold power level over the channel during the scheduled wake-up time. The instructions may further be operable to cause the processor to identify a NAN DW for transmission of a beacon including clock synchronization information and the time stamp of the station based at least in part on the determining, and transmit the beacon including clock synchronization information and the time stamp of the station over at least one NDL during the identified NAN DW, where the beacon includes paging attributes for one or more of the at least one NDLs.

In some examples of the method, apparatus, and non-transitory computer-readable medium described above, the NAN DW may be identified via a random selection. In some examples of the method, apparatus, and non-transitory computer-readable medium described above, the NAN DW may be identified based at least in part on a media access control (MAC) address of the station.

A method of wireless communication is described. The method may include detecting a loss of a clock synchronization signal from a second station, where the first station and the second station are members of a NAN, and transmitting a NAN management message to a third station of the NAN over an NDL, the NAN management message including an indication of the detected loss of the clock synchronization signal from the second station. The method may further include receiving a beacon including clock synchronization information from the third station based at least in part on the NAN management message.

A wireless device for wireless communication is described. The wireless device may include a wireless modem. The wireless modem may be configured to identify a loss of a clock synchronization signal from a second station, where the first station and the second station are members of a NAN. The wireless modem may be further configured to provide for transmission, a NAN management message to a third station of the NAN over an NDL, the NAN management message including an indication of the detected loss of the clock synchronization signal from the second station. The wireless modem may be further configured to obtain a beacon including clock synchronization information from the third station based at least in part on the NAN management message.

An apparatus for wireless communication is described. The apparatus may include means for detecting a loss of a clock synchronization signal from a second station, where the first station and the second station are members of a NAN, means for transmitting a NAN management message to a third station of the NAN over an NDL, the NAN management message including an indication of the detected loss of the clock synchronization signal from the second station, and means for receiving a beacon including clock synchronization information from the third station based at least in part on the NAN management message.

Another apparatus for wireless communication is described. The apparatus may include a processor, memory in electronic communication with the processor, and instructions stored in the memory. The instructions may be operable to cause the processor to detect a loss of a clock synchronization signal from a second station, where the first station and the second station are members of a NAN, transmit a NAN management message to a third station of the NAN over an NDL, the NAN management message including an indication of the detected loss of the clock synchronization signal from the second station, and receive a beacon including clock synchronization information from the third station based at least in part on the NAN management message.

A non-transitory computer-readable medium for wireless communication is described. The non-transitory computer-readable medium may include instructions operable to cause a processor to detect a loss of a clock synchronization signal from a second station, where the first station and the second station are members of a NAN, transmit a NAN management message to a third station of the NAN over an NDL, the NAN management message including an indication of the detected loss of the clock synchronization signal from the second station, and receive a beacon including clock synchronization information from the third station based at least in part on the NAN management message.

In some examples of the method, wireless device, apparatus, and non-transitory computer-readable medium described above, transmitting the NAN management message to the third station of the NAN comprises: transmitting the NAN management message to a plurality of stations of the NAN, the plurality of stations including the third station. In some examples of the method, apparatus, and non-transitory computer-readable medium described above, receiving the beacon including clock synchronization information from the third station comprises: receiving a plurality of beacons from the plurality of stations of the NAN in response to the NAN management message. Some examples of the method, apparatus, and non-transitory computer-readable medium described above may further include processes, features, means, or instructions for selecting one of the plurality of stations as a new source of clock synchronization information for the first station based at least in part on the plurality of beacons.

Some examples of the method, wireless device, apparatus, and non-transitory computer-readable medium described above may further include processes, features, means, or instructions for transmitting a second NAN management message to the third station over the NDL based at least in part on the selection of the one of the plurality of stations as the new source of clock synchronization information, the second NAN management message including a request to suspend beacon transmission.

Some examples of the method, wireless device, apparatus, and non-transitory computer-readable medium described above may further include processes, features, means, or instructions for detecting a new beacon transmission from the second station. Some examples of the method, apparatus, and non-transitory computer-readable medium described above may further include processes, features, means, or instructions for transmitting a second NAN management message to the third station over the NDL based at least in part on the new beacon transmission from the second station, the second NAN management message including a request to suspend beacon transmission. In some examples of the method, apparatus, and non-transitory computer-readable medium described above, the NAN management message may be transmitted during a time duration consisting of one of a NAN DW, a NAN further availability window (FAW), and an NDL TB. In some examples of the method, apparatus, and non-transitory computer-readable medium described above, the NAN management message further comprises an indication for the third station to transmit a beacon to the station.

### BRIEF DESCRIPTION OF THE DRAWINGS

FIG. 1 illustrates an example of a wireless local area network (WLAN) that supports synchronization techniques for neighbor awareness network (NAN) device links (NDLs) in accordance with aspects of the present disclosure.

FIG. 2 illustrates an example of a WLAN that supports synchronization techniques for NDLs in accordance with aspects of the present disclosure.

FIG. 3 illustrates an example of a process flow that supports synchronization techniques for NDLs in accordance with aspects of the present disclosure.

FIG. 4 illustrates an example of a process flow that supports synchronization techniques for NDLs in accordance with aspects of the present disclosure.

FIGS. 5 through 7 show block diagrams of a device that supports synchronization techniques for NDLs in accordance with aspects of the present disclosure.

FIG. 8 illustrates a block diagram of a system including a station (STA) that supports synchronization techniques for NDLs in accordance with aspects of the present disclosure.

FIGS. 9 through 13 illustrate methods for synchronization techniques for NDLs in accordance with aspects of the present disclosure.

### DETAILED DESCRIPTION

The described features generally relate to improved systems, methods, and/or apparatuses for clock synchronization between devices in a neighbor awareness network (NAN). More specifically, the techniques described herein may allow for more frequent and/or tighter clock synchronization of stations (STAs) associated with a NAN device link (NDL), thus improving communications within a NAN.

Wireless devices in a NAN (e.g., NAN devices) may share a common set of parameters for communications (e.g., a time duration of discovery windows (DWs), a beacon interval, NAN discovery channel(s), etc.). Within the NAN, devices that share a common set of NAN parameters and are synchronized according to a same DW schedule may be referred to as a NAN cluster. NAN devices participating in the NAN cluster may be synchronized to a common clock. A timing synchronization function (TSF) may be used to keep the timers of all NAN devices in the same NAN cluster synchronized. During a DW (e.g., of the NAN DW schedule), one or more NAN devices may transmit NAN synchronization beacon frames such that other NAN devices within the NAN cluster may synchronize their clocks (e.g., an Anchor Master's clock information may be propagated through the NAN cluster via synchronization beacons from other NAN devices, which may take on Master and Non-Master roles). Further, a NAN data cluster (NDC) may refer to two or more NAN devices in a NAN cluster that share a common NDC schedule (e.g., base schedule) identifying when each NAN device is awake. Each member device in the NDC may have at least one NDL with another member device within the same NDC. Such NDLs may be established between two devices within the NDC to ensure resources (e.g., Common Resource Blocks (CRBs)) for direct communications between the two devices. NAN devices of an NDC may maintain tight synchronization amongst each other and may be present or awake at the same NDC CRBs indicated by the NDC base schedule.

In some cases, a NAN device may lose clock synchronization (e.g., if a parent device, Master device, Anchor Master device, or other device providing synchronization beacons moves away, leaves the network, is no longer beaconing, etc.). Some NAN devices (e.g., devices of an NDC) may be associated with relatively small wake-up cycles, and tight clock synchronization may be desired. For example, NDLs may be disrupted if NAN devices associated with the NDL are not closely synchronized, as wake-up times for each participant of the NDL should align with the time block (TB) schedule associated with the NDL.

Synchronization techniques for NDLs, as discussed herein, may allow for more frequent and/or tighter clock synchronization of NAN devices (e.g., stations (STAs)) associated with an NDL. STAs of an NDC may contend for synchronization beacon transmission during wake-up times associated with NDC base schedules. For example, STAs may deterministically decide when to transmit synchronization beacons over channel(s) associated with the NDC. STAs may determine when to transmit synchronization beacons (e.g., during wake-up times, contention windows (CWs), etc. defined by the NDC base schedule) based on a variety of criteria. For example, a wait time duration may be determined based on a time duration since clock synchronization information was last received by the station. In other examples, a probabilistic transmission parameter (e.g., transmission probability) may be determined based on a number of NDLs associated with the station. In yet other examples, the station may determine a number of TBs since a previous beacon transmission from the station (e.g., the number of TBs since the station was last able to advertise), which may also be used to determine when the station may transmit a beacon during the NDC wake-up time (e.g., the station may transmit a beacon after x TBs have passed without the station having transmitted a beacon). In some cases, a field or element to carry clock information (e.g., time stamp information) may be included at the beginning of each NDL TB. Further, paging techniques may be modified to include beacons, include clock information in paging messages, etc.

According to other embodiments of the present disclosure, a STA may indicate when it detects missing beacons, or when a loss of clock synchronization has occurred. For example, a STA may signal other peer STAs (e.g., the STA may signal a NAN management message or a NAN Management Frame (NMF) to other STAs of a same NDC, to another STA associated with an established NDL, etc.), when the STA detects disappearance of synchronization beacons (e.g., loss of clock synchronization). The NMF may, in addition to indicating a loss of clock synchronization, include requests for the one or more other STAs to start beacon transmissions (e.g., for the STA to obtain clock information) or stop beacon transmissions (e.g., if clock information has been obtained by the STA) as desired.

Aspects of the disclosure are initially described in the context of a wireless communications system. Process flows illustrating techniques to prevent and/or manage loss of clock synchronization are then described. Aspects of the disclosure are further illustrated by and described with reference to apparatus diagrams, system diagrams, and flowcharts that relate to synchronization techniques for NDLs.

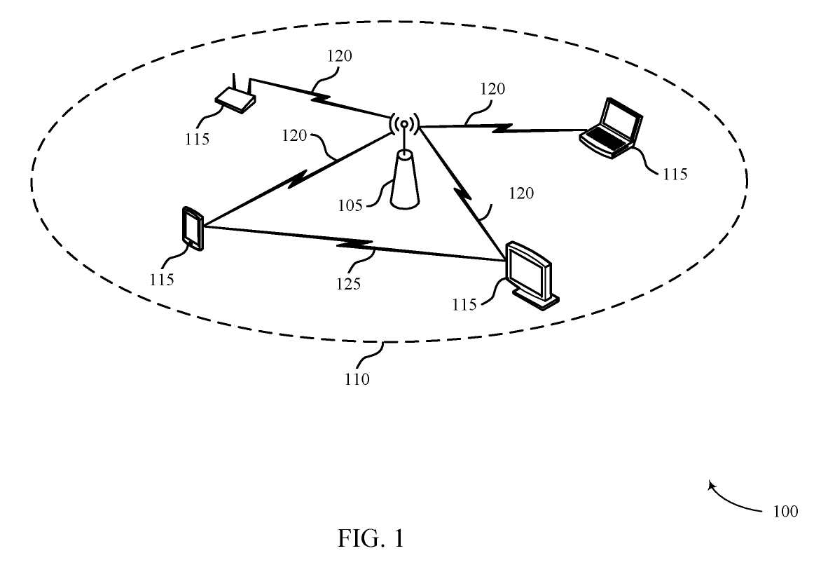

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a BSS of the WLAN 100. An extended network station (not shown) associated with the WLAN 100 may be connected to a wired or wireless distribution system that may allow multiple APs 105 to be connected in an ESS.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

In some cases, multiple STAs 115 may be organized into a NAN that includes one or more NDCs. These STAs 115 may use the techniques described in this specification to maintain clock synchronization between the different STAs 115 in the NAN, or if one of the STAs 115 loses a clock synchronization source, to signal that loss to other STAs 115 in the NAN.

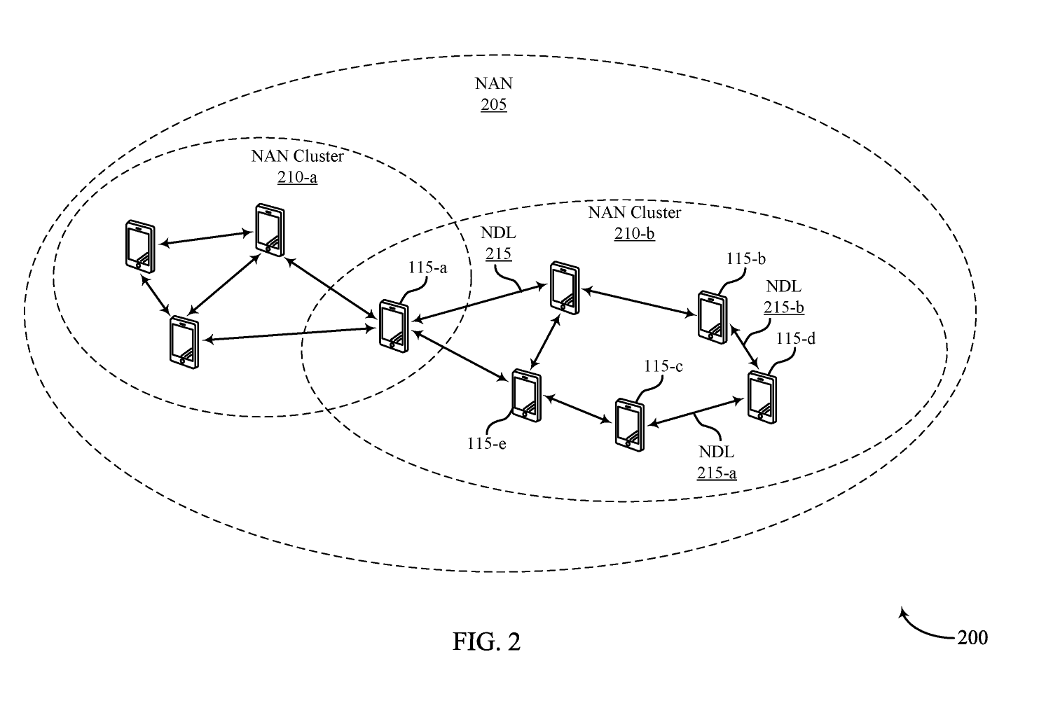

FIG. 2 illustrates an example of a WLAN 200 that supports synchronization techniques for NDLs in accordance with various aspects of the present disclosure. In some examples, WLAN 200 may implement aspects of WLAN 100. WLAN 200 may include STA 115-a, STA 115-b, STA 115-c, and STA 115-d, which may be examples of a STA 115 described above with reference to FIG. 1. WLAN 200 may operate according to a NAN protocol (e.g., WLAN 200 may include a NAN 205). NAN 205 may include several NAN devices (e.g., STAs 115) that share a common set of NAN parameters such as a time period between consecutive DWs, a time duration of the DWs, a beacon interval, NAN Discovery Channel(s), etc. NAN devices or STAs 115 of NAN 205 may exchange service discovery messages or set-up messages during NAN DWs or NAN further availability windows (FAWs).

The NAN 205 may further include NAN clusters 210, which may include NAN devices that share the common set of NAN parameters as well as maintain synchronization to a same DW schedule. That is, STAs 115 within NAN cluster 210-a may refer to a subset of STAs 115 within NAN 205 that are synchronized according to a particular DW schedule, while NAN cluster 210-b may refer to a second subset of STAs 115 within NAN 205 that are synchronized according to a different DW schedule. STAs 115 that are part of a same NAN cluster 210 may be associated with a same NAN cluster ID and may participate in NAN Master/Non-Master selection procedures, etc. to facilitate synchronization and communications within the NAN cluster 210. In some cases, NAN devices may be awake during a DW associated with the NAN 205 (e.g., a DW0) as well as during one or more other DWs associated with the NAN cluster 210. For communications between two NAN devices, an NDL 215 may be established. NDLs 215 may, for example, ensure two communicating NAN devices share sufficient NDL CRBs to accommodate communications.

NAN devices (e.g., STAs 115) may further be divided into NAN data clusters (NDCs). For example, STA 115-b, STA 115-c, and STA 115-d may form an NDC. NAN devices in an NDC may share a common NDC schedule identifying when each NAN device is awake. Each member device in the NDC may have at least one NDL with another member device within the same NDC. That is, each member of the NDC (e.g., each of STA 115-b, STA 115-c, and STA 115-d) may have at least one NDL 215 with another device within the NDC. In some cases, a NAN device may be a member of more than one NDC, however each NDL may be associated with only two members of the NDC (e.g., each NDL may be unique to the two connected STAs 115). According to the NDC, STA 115-b, STA 115-c, and STA 115-d may maintain tight synchronization with each other and may be awake or present during the same NDC CRBs, and monitor the same channel, as indicated by the NDC base schedule. Further, each NDL may be associated with a schedule, which may be a superset of the NDC schedule.

In the present example, STA 115-a may refer to a NAN device operating in an Anchor Master role or a Master role and may be associated with two NAN clusters 210, while other STAs 115 shown may operate in either Master or Non-Master roles, and may be associated with either NAN cluster 210-a or NAN cluster 210-b. In some cases, when a STA 115 operates in a Non-Master role, the STA 115 may monitor for synchronization transmissions. When a STA 115 operates in a Master role, the STA 115 may transmit NAN synchronization beacons and NAN discovery beacon frames to maintain synchronization within the NAN 205, NAN cluster 210, etc. In some cases, STA 115-a may refer to an Anchor Master NAN device. An Anchor Master may refer to a NAN device that has the highest Master Rank in a NAN cluster. STAs 115 in a NAN cluster 210 may follow the TSF of the Anchor Master (e.g., STA 115-a). That is, STAs 115 that are not operating as an Anchor Master may adopt the TSF timer value in a NAN synchronization beacon frame received with the same Cluster ID as the NAN Device's own Cluster ID (e.g., received directly from the Anchor Master or received from other STAs 115 via a series of NDLs 215).

That is, a NAN cluster 210 may include one or more STAs 115 that have synchronized clocks (e.g., the Anchor Master's clock information may be propagated through the NAN cluster 210 via synchronization beacons from other STAs 115, which may take on Master and Non-Master roles). STAs 115 of the NAN cluster 210 may form NDLs with one another by negotiating a wake-up schedule (e.g., some repeating TB). In some cases, a STA 115 may lose clock synchronization (e.g., if a parent device, Master device, Anchor Master moves away, leaves the network, is no longer beaconing, etc.). NDLs 215 may be disrupted if the two STAs 115 associated with the NDL 215 are not synchronized, as wake-up times for each participant of the NDL should align with the TB schedule associated with the NDL. NDC devices, such as STA 115-b, STA 115-c, and STA 115-d, may be associated with even smaller wake-up cycles, and synchronization may be even more crucial.

Synchronization techniques for NDLs, as discussed herein, may allow for more frequent and/or tighter clock synchronization of STAs 115 associated with an NDL, thus improving overall NAN performance. For example, a STA 115 may signal other peer STAs 115 (e.g., another STA 115 associated with an established NDL), when the STA 115 detects disappearance of synchronization beacons. In other examples, a subset of NDC participants may contend for synchronization beacon transmission during NDC base schedules (e.g., according to timing and channel(s) associated with the NDC), NDC participants may transmit clock information along with paging messages, Non-Master Non-Sync (NMNS) devices may be allowed to send beacons, etc. In other cases, new mechanisms may be devised to convey synchronization information. For example, a field or element for carrying timestamp information may be included at the beginning of each NDL TB, new NMFs may be defined, etc. Such techniques and mechanisms for improved synchronization for NDLs are now discussed in further detail below.

In some cases, NDC participants may deterministically decide (i.e., contend for) when to transmit synchronization beacons during a wake-up time of an NDC base schedule (e.g., an NDC epoch or time/channel information established for the NDC communications). For example, STA 115-b, STA 115-c, and STA 115-d may contend to (or for example, deterministically decide when to) send synchronization beacons at the beginning of NDC base schedule periods. In some cases, the CW used by a STA 115 to send a synchronization beacon may be a function of the time of the last clock update the STA 115 received from the Anchor Master, such that STAs 115 with a more current clock may transmit synchronization beacons first. For example, if STA 115-d (i.e., a NAN device of the NDC) received a clock update from STA 115-a (i.e., the Anchor Master) more recently than STA 115-b and STA 115-c, then STA 115-d may use a CW earlier in the scheduled wake-up time (e.g., as defined by the NDC base schedule) than STA 115-b and STA 115-c. As such, STA 115-d may transmit one or more synchronization beacons (e.g., via NDL 215-a and/or NDL 215-b) to STA 115-c and/or STA 115-b. STA 115-c and STA 115-b may use the synchronization beacons to update their own clock information (e.g., as the clock information received from STA 115-d may be associated with an earlier time stamp). That is, other STAs 115 (e.g., STA 115-c and STA 115-b) may suspend synchronization beacon transmission when a beacon is received (e.g., from STA 115-d) with a time stamp younger than its own time stamp. In this manner, STAs 115 of an NDC may be updated with the most current clock information a member of the NDC has attained from the Anchor Master (e.g., or other parent or Master device), and beacons with less recent clock information may be suspended.

In other cases, STAs 115 may transmit synchronization beacons (e.g., within an NDC scheduled wake-up time) according to some probabilistic transmission parameter (e.g., to reduce the number of devices that are beaconing). For example, STAs 115 with a larger number of transmitters and/or receivers (e.g., STAs 115 associated with a larger number of NDLs) may participate in beacon transmissions with a higher probability. For example, as STA 115-e is associated with a larger number of STAs (e.g., associated with three NDLs) than STA 115-c (e.g., associated with two NDLs), STA 115-e may transmit beacons with a higher transmission probability (e.g., during a particular CW, NDC scheduled wake-up time, etc.) than STA 115-e (e.g., during the same CW, NDC scheduled wake-up time, etc.). In yet other cases, a NAN 205, NAN cluster 210, and/or NDC may establish other rules for beacon transmissions within an NDC scheduled wake-up time. For example, a rule may state that a STA 115 may attempt to advertise clock information (e.g., a timestamp) if the STA 115 has not had a chance or has not been able to advertise in some number of TBs (e.g., a STA 115 may attempt to transmit a beacon or advertise a time stamp if the STA 115 has not been able to advertise in the last x TBs).

Other solutions may include a beacon being sent prior to sending any paging frames (e.g., via paging NDLs (P-NDLs)) between NAN devices. As such, clock information may be updated (e.g., via beacons) each time a STA 115 is paged by another STA 115. In other cases, paging attributes may be sent in synchronization beacons.

In some examples, a field or an element may carry clock information (e.g., a time stamp) at the beginning of each NDL TB. For P-NDLs, the clock information may be carried in the paging message during the paging window (PW). Other STAs 115 may be awake during the PW to listen for paging messages and may receive the clock information. Such a technique may not require additional signaling overhead for the STA 115 signaling the page since the click information may be piggybacked as another field or element. For synchronization NDLs (S-NDLs), STAs 115 may attempt to send clock information at the beginning of the TB (e.g., there may be a short ‘sync’ window at the beginning of each TB).

As discussed above, STAs 115 may advertise clock information based on information received from another STA (e.g., another STA operating as an Anchor Master device, Master device, parent device, etc.) during a NAN DW. When multiple STAs advertise clock information (e.g., advertise time stamps), the oldest time stamp of the advertised clock information may be adopted by the multiple STAs, as the oldest time stamp may correspond to the latest (i.e., most recent) clock update. In some cases, STAs 115 may follow some suppression rules (e.g., rules for a STA advertising clock information if such information has not been conveyed in the last x TBs, rules for suppressing time stamp advertisement if an announcement is heard from another device during the same TB that is later or more recent than the STAs time stamp, etc.). In some cases, such suppression rules may be used in combination with each other. If a beaconer is lost during the DW, such NAN recovery mechanisms may be implemented.

According to another embodiment of the disclosure, a new NMF may be defined to enable a STA 115 to inform its peers (e.g., other STAs associated with the same NDC ID) that it has lost its clock (e.g., lost clock synchronization with the NDC, NAN, etc.). For example, if STA 115-d determines it has lost its clock, STA 115-d may send an NMF frame informing STA 115-b and STA 115-c. The NMF may be sent during a NAN DW, NAN FAW, an NDL TB (e.g., when the other peer associated with the NDL has indicated that it will be awake and available to communicate), etc. Fields in the NMF may indicate additional commands or other information in addition to the loss of clock indication. For example, the NMF may include information requesting the peer (e.g., the STA 115 receiving the NMF) start beaconing (e.g., so the STA 115 sending the NMF may receive clock information from the peer receiving the NMF). In some cases, this may increase master rank and beacon during the DW. In other cases, the NMF may request a beacon be sent by the peer only during NDC. In other examples, the NMF may include information requesting the peer (e.g., the STA 115 receiving the NMF) stop beaconing (e.g., if the original beaconer returns or is able to receive beacons from some other STA in the NAN cluster). In cases where the STA 115 that lost its clock may be involved in more than one NDL, the STA 115 may request multiple peers (e.g., a peer associated with each NDL) to take on the role of a beaconer. The STA 115 may then determine the most suitable beacon to use for updating/maintaining clock information. After requesting such information from the multiple peers, the STA 115 may transmit an NMF with the stop indication or stop beaconer to other peers once a suitable beaconer is found.

In some examples, a NMNS device may be allowed to transmit beacons at certain DW intervals. When a NAN Device (e.g., a STA 115) switches from a Master role to a Non-Master role, it may initially assume a Sync state, until it transitions to a Non-Sync state during a DW, if such a transition occurs. A STA 115 in a NMNS state may remain in the Non-Sync state and may only transition to a Non-Master Sync state or transition to a Master role at the end of a DW, if such a transition occurs. Such NMNS STAs 115 may transmit beacons at specific DW intervals. For example, a NMNS STA 115 may choose its own DW (e.g., between DW0 and DW15) at random, for beacon transmission. In other examples, a NMNS STA 115 may send a beacon at a DW index corresponding to its MAC address (e.g., mod 16). This may allow for a predictable beacon from the NMNS STA 115 (e.g., predictable by other NAN devices). In some cases, an NMNS STA 115 beacon transmission may be limited to NMNS STAs 115 that are currently participating in an NDL.

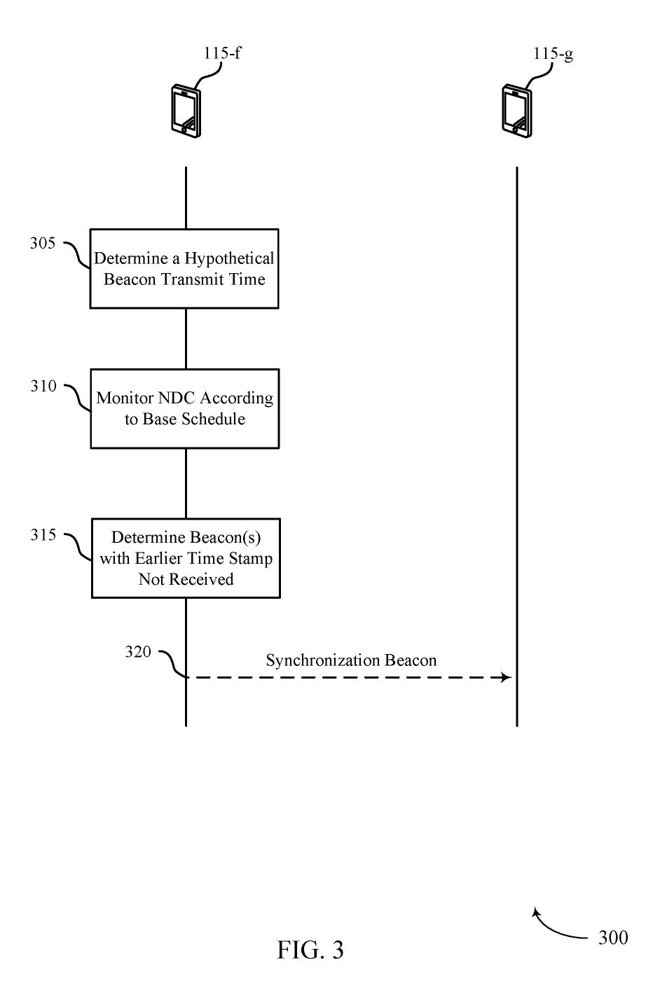

FIG. 3 illustrates an example of a process flow 300 that supports synchronization techniques for NDLs in accordance with various aspects of the present disclosure. In some examples, process flow 300 may implement aspects of WLAN 100 and/or WLAN 200. Process flow 300 may include STA 115-f and STA 115-g, which may be examples of STAs 115 described above with reference to FIGS. 1 and 2. Process flow 300 may illustrate techniques for proactive clock synchronization (e.g., techniques to maintain clock synchronization/prevent loss of clock synchronization).

At 305, STA 115-f may determine a hypothetical beacon transmission time or a wait time duration (e.g., an opportunistic transmission parameter, a CW within the wake-up time as defined by the NDC base schedule, etc.) for a next or current NDC wake-up time. For example, a wait time duration may be determined based on a time duration since clock synchronization information was last received by the STA 115-f. In other examples, the hypothetical beacon transmission time may refer to some probabilistic transmission parameter (e.g., transmission probability) based on a number of NDLs associated with the STA 115-f. In yet other examples, the STA 115-f may determine a number of TBs since a previous beacon transmission from the STA 115-f (e.g., the number of TBs since the STA 115-f was last able to advertise), which may also be used to determine when the STA 115-f may transmit a beacon during the NDC wake-up time.

At 310, STA 115-f may monitor the NDC channel during the wake-up time (e.g., as defined by the NDC base schedule) for beacons from other STAs 115 (e.g., STA 115-g).

At 315, STA 115-f may determine a beacon has not been received prior to the hypothetical beacon transmission time determined at 305 (e.g., before the determined wait time). That is, STA 115-f may determine that no beacon has been received that includes an earlier time stamp than the time stamp of the STA 115-f. For example, in some cases, the STA 115-f may determine that no beacons including an earlier time stamp than a time stamp of the station has been received (e.g., STA 115-f may determine that a number of beacons including an earlier time stamp than a time stamp of the station has been received at a power level of zero). In other words, the STA 115-f may have either stopped receiving beacons or may determine that no beacons have been received (e.g., prior to the hypothetical beacon transmission time), based on the power level indicating an absence of any measurable power or no-power.

At 320, STA 115-f may transmit, via an NDL, a beacon including STA 115-f clock information (e.g., clock synchronization information and a time stamp) to STA 115-g after the determined wait time, at the hypothetical beacon transmit time, according to the probabilistic transmission parameter, etc. In some cases, the STA 115-f may determine that a certain number of TBs has passed since the STA 115-f was last able to transmit a beacon (e.g., x TBs), and the STA 115-f may transmit the beacon based on that determination. In some cases, STA 115-f may transmit the beacon to other STAs 115 (e.g., via other NDLs). In some cases, the STA 115-f may switch from monitoring the NDC channel to transmitting the beacon (e.g., the STA 115-f may switch it's role from monitoring, as a non-beaconer, to beacon transmitting, as a beaconer) based on the determination at 315 (e.g., based on the power level of beacons including an earlier time stamp than a time stamp of the station indicating an absence of any measurable power or no-power). For example, in some cases, the STA 115-f may start sending beacons based on a determination that a number of beacons including an earlier time stamp than a time stamp of the station has been received at a power level of effectively zero.

In some other examples, the STA 115-f may transmit a paging message at 320. The clock information (e.g., a time stamp of STA 115-f) may be carried in the paging message. However, in some cases (e.g., when a STA 115-f has determined that a beacon has been received that includes an earlier time stamp than the time stamp of the STA 115-f), the STA 115-f may suspend beacon transmission (e.g., delay or not perform 320). In some examples, the time stamp of the STA 115-f (e.g., and other clock information) may have been received previously from some other NAN device (e.g., an Anchor Master device, Master device, other NAN device, etc.) during a NAN DW.

Additionally or alternatively, STA 115-f may identify a NAN DW for transmission of a beacon (e.g., a second beacon or the beacon of 320), based at least in part on 305-315 procedures. The STA 115-f may transmit the beacon over at least one NDL during the identified NAN DW, where the beacon includes paging attributes for one or more of the at least one NDLs.

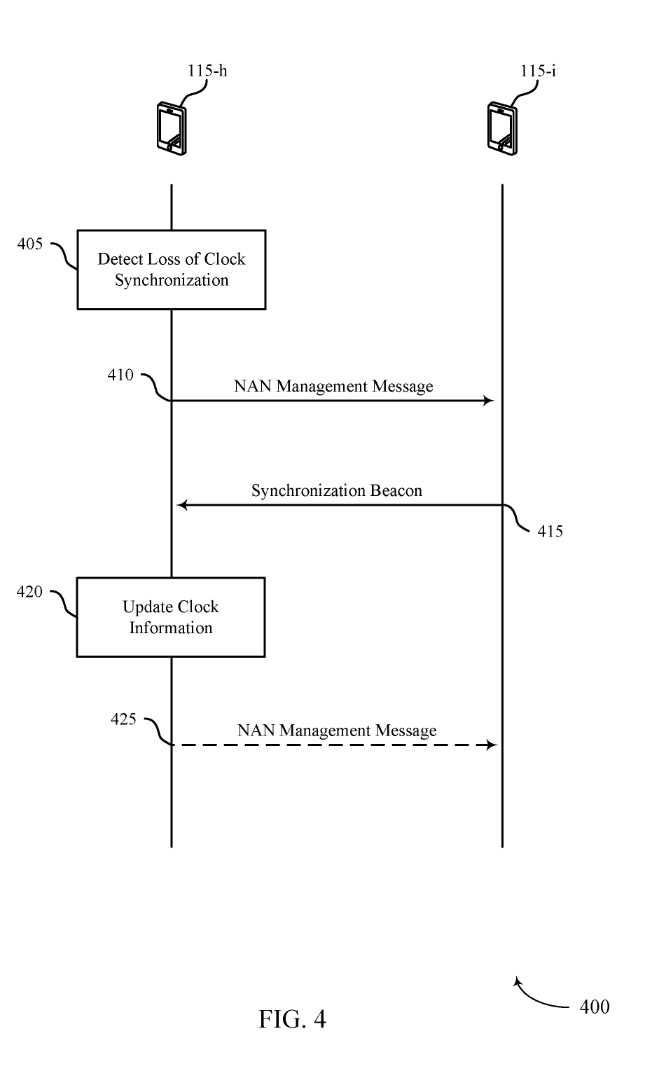

FIG. 4 illustrates an example of a process flow 400 that supports synchronization techniques for NDLs in accordance with various aspects of the present disclosure. In some examples, process flow 400 may implement aspects of WLAN 100 and/or WLAN 200. Process flow 400 may include STA 115-h and STA 115-i, which may be examples of STAs 115 described above with reference to FIGS. 1 and 2. Process flow 400 may illustrate techniques for reactive clock synchronization (e.g., techniques to manage loss of clock synchronization/resynchronize clock information).

At 405, STA 115-h may detect a loss of clock synchronization (e.g., a loss of a clock synchronization signal from some STA 115 such as an Anchor Master device, a Master device, or some other NAN device). For example, STA 115-h may determine it has lost clock synchronization with the NAN by detecting a disappearance or lack of beacons or synchronization signals (e.g., from the STA 115-h perspective) from some other STA or NAN device of the same NAN.

At 410, STA 115-h may transmit a NAN management message (e.g., an NMF) to another device of the NAN such as, for example, STA 115-i. STA 115-h may transmit the NAN management message over an NDL associated with STA 115-h and STA 115-i. The NAN management message may include an indication of the detected loss of the clock synchronization signal from the NAN or from some STA of the NAN as discussed at 405. In some cases, the NAN management message may be sent to several devices (e.g., other STAs 115 of the NAN in addition to STA 115-i, such as the STA 115 from which the loss of clock synchronization was detected at 405). Further, the NAN management message may include a request for the STA 115-i to start transmitting beacons to the STA 115-h. The NAN management message may be transmitted during some time duration such as a NAN DW, a NAN FAW, an NDL TB, etc.

At 415, STA 115-h may receive a synchronization beacon from STA 115-i. The beacon may include clock synchronization information from STA 115-i based at least in part on the NAN management message sent at 410. In some cases, STA 115-h may receive several beacons (e.g., from other STAs of the NAN as well as from STA 115-i). In such cases, the STA 115-h may select one of the STAs (e.g., STA 115-i) as a new source of clock synchronization information, based at least in part on the received beacons (e.g., based on the time stamp indicated by the STA 115-i beacon).

At 420, STA 115-h may update its clock information (e.g., via information included in the received synchronization beacon).

At 425, STA 115-h may optionally transmit a second NAN management message (e.g., an NMF), for example, to indicate to STA 115-i that synchronization beacons are no longer desired. For example, the NAN management message may include a request for STA 115-i to suspend beacon transmission (e.g., if STA 115-h has updated its clock from the beacon received at 415, or from some other beacon received from any other device in the NAN).

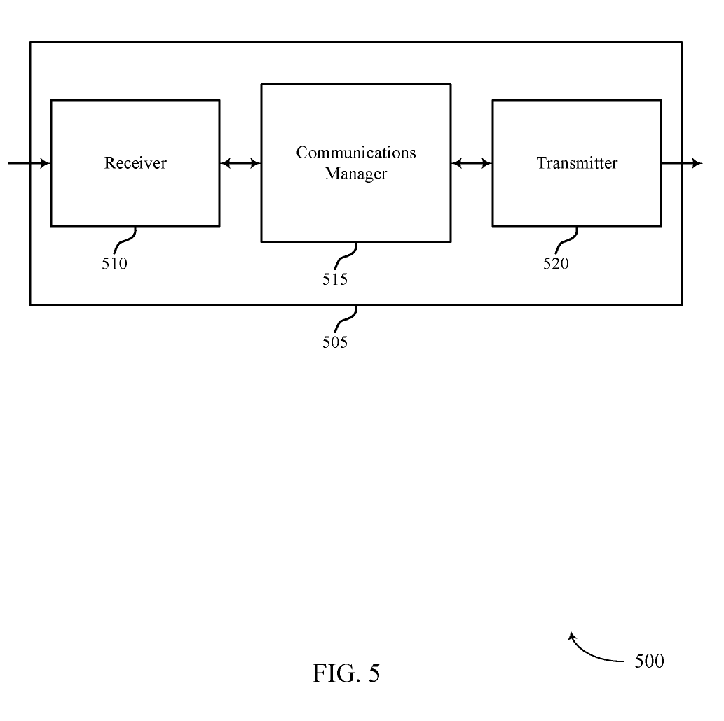

FIG. 5 shows a block diagram 500 of a wireless device 505 that supports synchronization techniques for NDLs in accordance with aspects of the present disclosure. Wireless device 505 may be an example of aspects of a STA 115 as described herein. Wireless device 505 may include receiver 510, communications manager 515, and transmitter 520. Wireless device 505 may also include a processor. Each of these components may be in communication with one another (e.g., via one or more buses). In some aspects, each of these components may, collectively or in any combination, be considered a wireless modem, or a subset of a wireless modem. In some aspects, the wireless modem may be a component of a wireless chip or chipset.

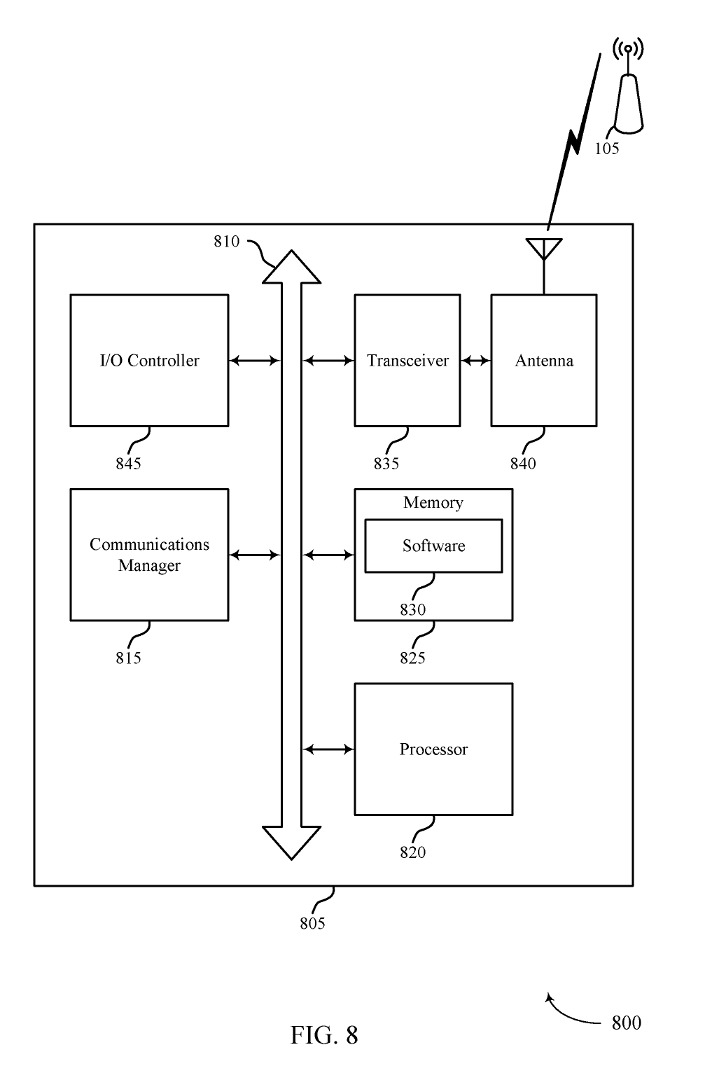

Receiver 510 may receive information such as packets, user data, or control information associated with various information channels (e.g., control channels, data channels, and information related to synchronization techniques for NDLs, etc.). Information may be passed on to other components of the device. The receiver 510 may be an example of aspects of the transceiver 835 described with reference to FIG. 8. The receiver 510 may utilize a single antenna or a set of antennas.

Communications manager 515 may be an example of aspects of the communications manager 815 described with reference to FIG. 8. Communications manager 515 and/or at least some of its various sub-components may be implemented in hardware, software executed by a processor, firmware, or any combination thereof. If implemented in software executed by a processor, the functions of the communications manager 515 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The communications manager 515 and/or at least some of its various sub-components may be physically located at various positions, including being distributed such that portions of functions are implemented at different physical locations by one or more physical devices. In some examples, communications manager 515 and/or at least some of its various sub-components may be a separate and distinct component in accordance with various aspects of the present disclosure. In other examples, communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 515 may monitor a wireless channel of an NDC at a scheduled wake-up time associated with the NDC and determine, based on the monitoring, that a threshold number of beacons including an earlier time stamp than a time stamp of the station has not been received at a power level above a threshold power level over the channel during the scheduled wake-up time. Communications manager 515 may transmit a beacon including clock synchronization information and the time stamp of the station over at least one NDL during the scheduled wake-up time based on the determining. In some cases, the beacon may include paging attributes for one or more of the at least one NDLs. Further, communications manager 515 may determine a number of TBs since a previous beacon transmission from the station and transmit a paging message during one of the one or more TBs, where the time stamp of the station is carried in the paging message. In some examples, communications manager 515 may identify a NAN DW for transmission of a beacon including clock synchronization information and the time stamp of the station based on the determining, and transmit the beacon including clock synchronization information and the time stamp of the station over at least one NDL during the identified NAN DW. The communications manager 515 may also detect a loss of a clock synchronization signal from a second station (e.g., a second station that is a member of the same NAN), transmit a NAN management message to a third station of the NAN over an NDL (e.g., the NAN management message including an indication of the detected loss of the clock synchronization signal from the second station), and receive a beacon including clock synchronization information from the third station based on the NAN management message.

Transmitter 520 may transmit signals generated by other components of the device. In some examples, the transmitter 520 may be collocated with a receiver 510 in a transceiver module. For example, the transmitter 520 may be an example of aspects of the transceiver 835 described with reference to FIG. 8. The transmitter 520 may utilize a single antenna or a set of antennas.

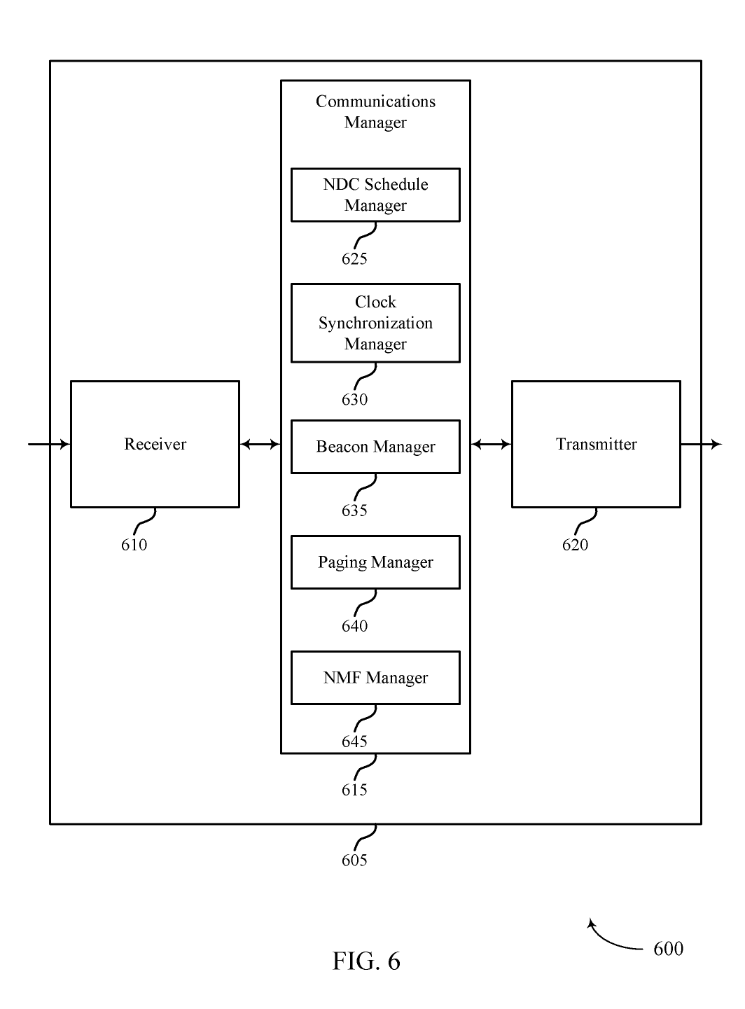

FIG. 6 shows a block diagram 600 of a wireless device 605 that supports synchronization techniques for NDLs in accordance with aspects of the present disclosure. Wireless device 605 may be an example of aspects of a wireless device 505 or a STA 115 as described with reference to FIG. 5. Wireless device 605 may include receiver 610, communications manager 615, and transmitter 620. Wireless device 605 may also include a processor. Each of these components may be in communication with one another (e.g., via one or more buses).

Receiver 610 may receive information such as packets, user data, or control information associated with various information channels (e.g., control channels, data channels, and information related to synchronization techniques for NDLs, etc.). Information may be passed on to other components of the device. The receiver 610 may be an example of aspects of the transceiver 835 described with reference to FIG. 8. The receiver 610 may utilize a single antenna or a set of antennas.

Communications manager 615 may be an example of aspects of the communications manager 815 described with reference to FIG. 8. Communications manager 615 may also include NDC schedule manager 625, clock synchronization manager 630, beacon manager 635, paging manager 640, and NMF manager 645 (e.g., NAN management message manager).

NDC schedule manager 625 may monitor a wireless channel of an NDC at a scheduled wake-up time associated with the NDC.

Clock synchronization manager 630 may determine that a threshold number of beacons including an earlier time stamp than a time stamp of the station has not been received at a power level above a threshold power level over the channel during the scheduled wake-up time. Clock synchronization manager 630 may receive a second beacon including an earlier time stamp than the time stamp of the station. Clock synchronization manager 630 may receive, from a second station, the clock synchronization information during a NAN DW, and detect a loss of a clock synchronization signal from the second station, where the first station and the second station are members of a NAN. In some cases, the threshold number of beacons is one beacon. In some cases, the threshold power level is based on a minimum power level for reception.

Beacon manager 635 may transmit a beacon including clock synchronization information and the time stamp of the station over at least one NDL during the scheduled wake-up time based on the determining. Beacon manager 635 may detect a new beacon transmission from the second station and determine a wait time duration from the scheduled wake-up time, where the wait time duration is determined based on a time duration since the clock synchronization information was received. Beacon manager 635 may transmit the beacon including clock synchronization information and the time stamp of the station after the determined wait time. Beacon manager 635 may transmit the beacon including clock synchronization information and the time stamp of the station according to the determined probabilistic transmission parameter. Beacon manager 635 may transmit the beacon including clock synchronization information and the time stamp of the station based on the determination. Beacon manager 635 may transmit a beacon including clock synchronization information and the time stamp of the station over at least one NDL during the scheduled wake-up time based on the determining, where the beacon includes paging attributes for one or more of the at least one NDLs. Beacon manager 635 may determine a number of TBs since a previous beacon transmission from the station. Beacon manager 635 may suspend beacon transmissions by the station based on the received second beacon. Beacon manager 635 may transmit the beacon including clock synchronization information and the time stamp of the station over at least one NDL during the identified NAN DW, where the beacon includes paging attributes for one or more of the at least one NDLs. Beacon manager 635 may receive a beacon including clock synchronization information from the third station based on the NAN management message and select one of the set of stations as a new source of clock synchronization information for the first station based on the set of beacons. Beacon manager 635 may identify a NAN DW for transmission of a beacon including clock synchronization information and the time stamp of the station based on the determining. In some cases, the NAN DW is identified via a random selection. In some cases, the NAN DW is identified based on a MAC address of the station. In some cases, receiving the beacon including clock synchronization information from the third station includes: receiving a set of beacons from the set of stations of the NAN in response to the NAN management message. Beacon manager 635 may identify that no beacons have been received based at least in part on the power level indicating no-power or an absence of any measurable power, and may determine to switch from the monitoring based at least in part on the identification, wherein the beacon is transmitted based at least in part on the determination.

Paging manager 640 may transmit a paging message during one of the one or more TBs, where the time stamp of the station is carried in the paging message.

NMF manager 645 may transmit a NAN management message to a third station of the NAN over an NDL, the NAN management message including an indication of the detected loss of the clock synchronization signal from the second station. NMF manager 645 may transmit a second NAN management message to the third station over the NDL based on the selection of the one of the set of stations as the new source of clock synchronization information, the second NAN management message including a request to suspend beacon transmission. NMF manager 645 may transmit a second NAN management message to the third station over the NDL based on the new beacon transmission from the second station, the second NAN management message including a request to suspend beacon transmission. In some cases, transmitting the NAN management message to the third station of the NAN includes transmitting the NAN management message to a set of stations of the NAN, the set of stations including the third station. In some cases, the NAN management message is transmitted during a time duration consisting of one of a NAN DW, a NAN FAW, and an NDL TB. In some cases, the NAN management message further includes an indication for the third station to transmit a beacon to the station.

Transmitter 620 may transmit signals generated by other components of the device. In some examples, the transmitter 620 may be collocated with a receiver 610 in a transceiver module. For example, the transmitter 620 may be an example of aspects of the transceiver 835 described with reference to FIG. 8. The transmitter 620 may utilize a single antenna or a set of antennas.

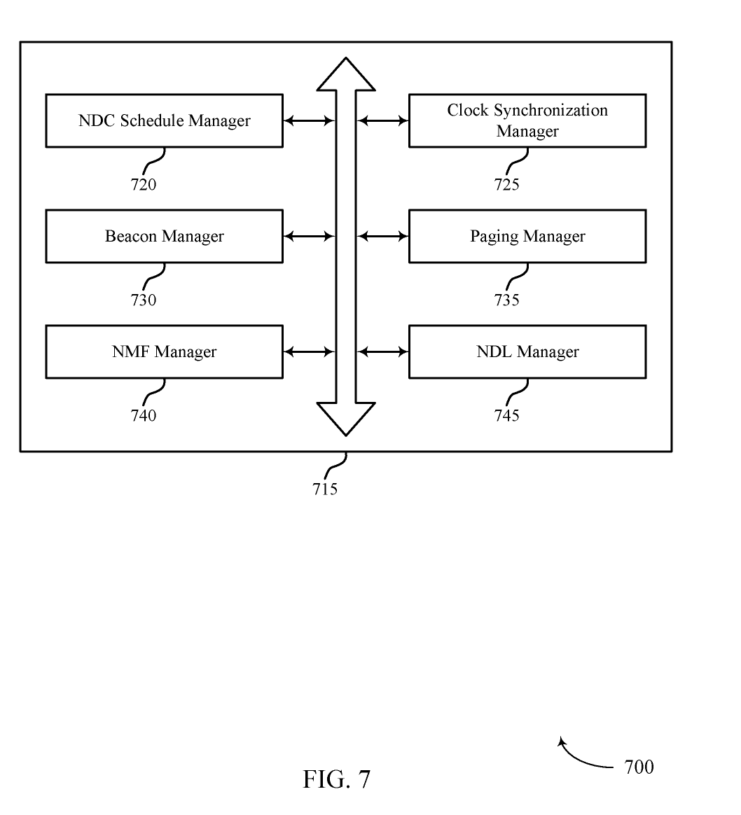

FIG. 7 shows a block diagram 700 of a communications manager 715 that supports synchronization techniques for NDLs in accordance with aspects of the present disclosure. The communications manager 715 may be an example of aspects of a communications manager 515, a communications manager 615, or a communications manager 815 described with reference to FIGS. 5, 6, and 8. The communications manager 715 may include NDC schedule manager 720, clock synchronization manager 725, beacon manager 730, paging manager 735, NMF manager 740, and NDL manager 745. Each of these modules may communicate, directly or indirectly, with one another (e.g., via one or more buses).

NDC schedule manager 720 may monitor a wireless channel of an NDC at a scheduled wake-up time associated with the NDC.

Clock synchronization manager 725 may determine, based on the monitoring, that a threshold number of beacons including an earlier time stamp than a time stamp of the station has not been received at a power level above a threshold power level over the channel during the scheduled wake-up time. Clock synchronization manager 725 may receive a second beacon including an earlier time stamp than the time stamp of the station. Clock synchronization manager 725 may receive, from a second station, the clock synchronization information during a NAN DW, and detect a loss of a clock synchronization signal from the second station, where the first station and the second station are members of a NAN. In some cases, the threshold number of beacons is one beacon. In some cases, the threshold power level is based on a minimum power level for reception.

Beacon manager 730 may transmit a beacon including clock synchronization information and the time stamp of the station over at least one NDL during the scheduled wake-up time based on the determining. Beacon manager 730 may detect a new beacon transmission from the second station. Beacon manager 730 may determine a wait time duration from the scheduled wake-up time, where the wait time duration is determined based on a time duration since the clock synchronization information was received. Beacon manager 730 may transmit the beacon including clock synchronization information and the time stamp of the station after the determined wait time. Beacon manager 730 may transmit the beacon including clock synchronization information and the time stamp of the station according to the determined probabilistic transmission parameter. Beacon manager 730 may transmit the beacon including clock synchronization information and the time stamp of the station based on the determination. Beacon manager 730 may transmit a beacon including clock synchronization information and the time stamp of the station over at least one NDL during the scheduled wake-up time based on the determining, where the beacon includes paging attributes for one or more of the at least one NDLs. Beacon manager 730 may determine a number of TBs since a previous beacon transmission from the station. Beacon manager 730 may suspend beacon transmissions by the station based on the received second beacon. Beacon manager 730 may transmit the beacon including clock synchronization information and the time stamp of the station over at least one NDL during the identified NAN DW, where the beacon includes paging attributes for one or more of the at least one NDLs. Beacon manager 730 may receive a beacon including clock synchronization information from the third station based on the NAN management message. Beacon manager 730 may select one of the set of stations as a new source of clock synchronization information for the first station based on the set of beacons. Beacon manager 730 may identify a NAN DW for transmission of a beacon including clock synchronization information and the time stamp of the station based on the determining. In some cases, the NAN DW is identified via a random selection. In some cases, the NAN DW is identified based on a MAC address of the station. In some cases, receiving the beacon including clock synchronization information from the third station includes receiving a set of beacons from the set of stations of the NAN in response to the NAN management message.

Paging manager 735 may transmit a paging message during one of the one or more TBs, where the time stamp of the station is carried in the paging message.

NMF manager 740 may transmit a NAN management message to a third station of the NAN over an NDL, the NAN management message including an indication of the detected loss of the clock synchronization signal from the second station. NMF manager 740 may transmit a second NAN management message to the third station over the NDL based on the selection of the one of the set of stations as the new source of clock synchronization information, the second NAN management message including a request to suspend beacon transmission. NMF manager 740 may transmit a second NAN management message to the third station over the NDL based on the new beacon transmission from the second station, the second NAN management message including a request to suspend beacon transmission. In some cases, transmitting the NAN management message to the third station of the NAN includes transmitting the NAN management message to a set of stations of the NAN, the set of stations including the third station. In some cases, the NAN management message is transmitted during a time duration consisting of one of a NAN DW, a NAN FAW, or an NDL TB. In some cases, the NAN management message further includes an indication for the third station to transmit a beacon to the station.

NDL manager 745 may determine a probabilistic transmission parameter based on a number of NDLs associated with the station and determine a number of TBs since a previous beacon transmission from the station.

FIG. 8 shows a diagram of a system 800 including a device 805 that supports synchronization techniques for NDLs in accordance with aspects of the present disclosure. Device 805 may be an example of or may include the components of wireless device 505, wireless device 605, or a STA 115 as described above, e.g., with reference to FIGS. 5 and 6. Device 805 may include components for bi-directional voice and data communications including components for transmitting and receiving communications, including communications manager 815, processor 820, memory 825, software 830, transceiver 835, antenna 840, and I/O controller 845. These components may be in electronic communication via one or more buses (e.g., bus 810).

Processor 820 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks supporting synchronization techniques for NDLs).

Memory 825 may include random access memory (RAM) and read only memory (ROM). The memory 825 may store computer-readable, computer-executable software 830 including instructions that, when executed, cause the processor to perform various functions described herein. In some cases, the memory 825 may contain, among other things, a basic input/output system (BIOS) which may control basic hardware or software operation such as the interaction with peripheral components or devices.

Software 830 may include code to implement aspects of the present disclosure, including code to support synchronization techniques for NDLs. Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas.

In some cases, the wireless device may include a single antenna 840. However, in some cases the device may have more than one antenna 840, which may be capable of concurrently transmitting or receiving multiple wireless transmissions.

I/O controller 845 may manage input and output signals for device 805. I/O controller 845 may also manage peripherals not integrated into device 805. In some cases, I/O controller 845 may represent a physical connection or port to an external peripheral. In some cases, I/O controller 845 may utilize an operating system such as iOS®, ANDROID®, MS-DOS®, MS-WINDOWS®, OS/2®, UNIX®, LINUX®, or another known operating system. In other cases, I/O controller 845 may represent or interact with a modem, a keyboard, a mouse, a touchscreen, or a similar device. In some cases, I/O controller 845 may be implemented as part of a processor. In some cases, a user may interact with device 805 via I/O controller 845 or via hardware components controlled by I/O controller 845.

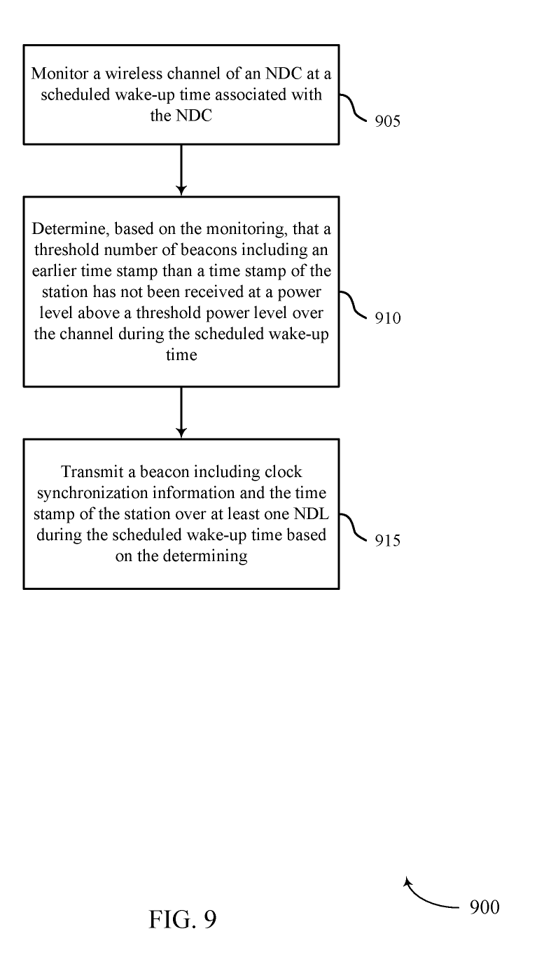

FIG. 9 shows a flowchart illustrating a method 900 for synchronization techniques for NDLs in accordance with aspects of the present disclosure. The operations of method 900 may be implemented by a STA 115 or its components as described herein. For example, the operations of method 900 may be performed by a communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At 905 the STA 115 may monitor a wireless channel of an NDC at a scheduled wake-up time associated with the NDC. The operations of 905 may be performed according to the methods described herein. In certain examples, aspects of the operations of 905 may be performed by an NDC schedule manager as described with reference to FIGS. 5 through 8.

At 910 the STA 115 may determine, based at least in part on the monitoring, that a threshold number of beacons including an earlier time stamp than a time stamp of the station has not been received at a power level above a threshold power level over the channel during the scheduled wake-up time. The operations of 910 may be performed according to the methods described herein. In certain examples, aspects of the operations of 910 may be performed by a clock synchronization manager as described with reference to FIGS. 5 through 8.

At 915 the STA 115 may transmit a beacon including clock synchronization information and the time stamp of the station over at least one NDL during the scheduled wake-up time based at least in part on the determining. The operations of 915 may be performed according to the methods described herein. In certain examples, aspects of the operations of 915 may be performed by a beacon manager as described with reference to FIGS. 5 through 8.

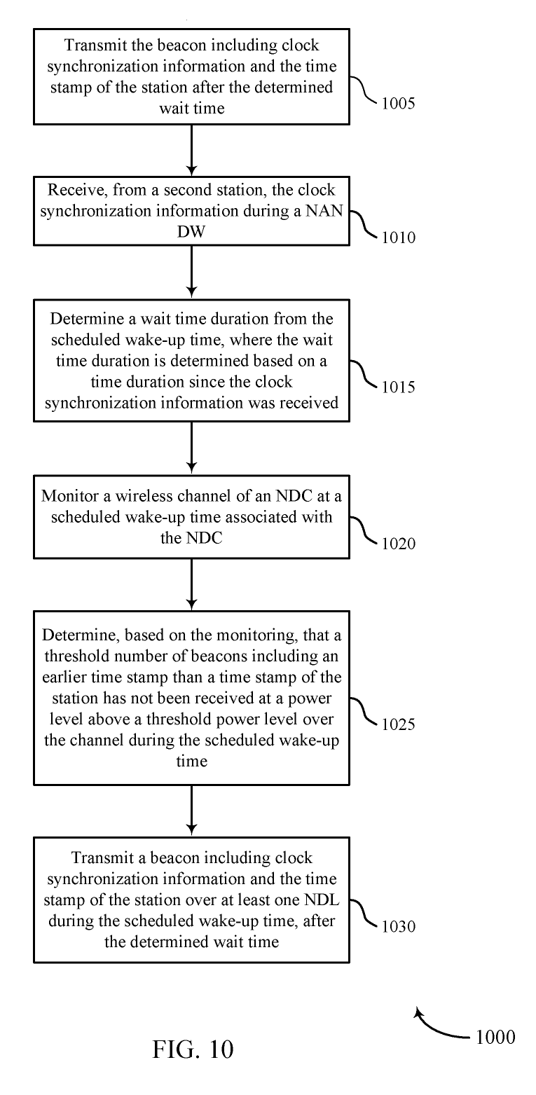

FIG. 10 shows a flowchart illustrating a method 1000 for synchronization techniques for NDLs in accordance with aspects of the present disclosure. The operations of method 1000 may be implemented by a STA 115 or its components as described herein. For example, the operations of method 1000 may be performed by a communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At 1005 the STA 115 may transmit the beacon including clock synchronization information and the time stamp of the station after the determined wait time. The operations of 1005 may be performed according to the methods described herein. In certain examples, aspects of the operations of 1005 may be performed by a beacon manager as described with reference to FIGS. 5 through 8.

At 1010 the STA 115 may receive, from a second station, the clock synchronization information during a NAN DW. The operations of 1010 may be performed according to the methods described herein. In certain examples, aspects of the operations of 1010 may be performed by a clock synchronization manager as described with reference to FIGS. 5 through 8.

At 1015 the STA 115 may determine a wait time duration from the scheduled wake-up time, where the wait time duration is determined based at least in part on a time duration since the clock synchronization information was received. The operations of 1015 may be performed according to the methods described herein. In certain examples, aspects of the operations of 1015 may be performed by a beacon manager as described with reference to FIGS. 5 through 8.

At 1020 the STA 115 may monitor a wireless channel of an NDC at a scheduled wake-up time associated with the NDC. The operations of 1020 may be performed according to the methods described herein. In certain examples, aspects of the operations of 1020 may be performed by an NDC schedule manager as described with reference to FIGS. 5 through 8.

At 1025 the STA 115 may determine, based at least in part on the monitoring, that a threshold number of beacons including an earlier time stamp than a time stamp of the station has not been received at a power level above a threshold power level over the channel during the scheduled wake-up time. The operations of 1025 may be performed according to the methods described herein. In certain examples, aspects of the operations of 1025 may be performed by a clock synchronization manager as described with reference to FIGS. 5 through 8.

At 1030 the STA 115 may transmit a beacon including clock synchronization information and the time stamp of the station over at least one NDL during the scheduled wake-up time, after the determined wait time. The operations of 1030 may be performed according to the methods described herein. In certain examples, aspects of the operations of 1030 may be performed by a beacon manager as described with reference to FIGS. 5 through 8.

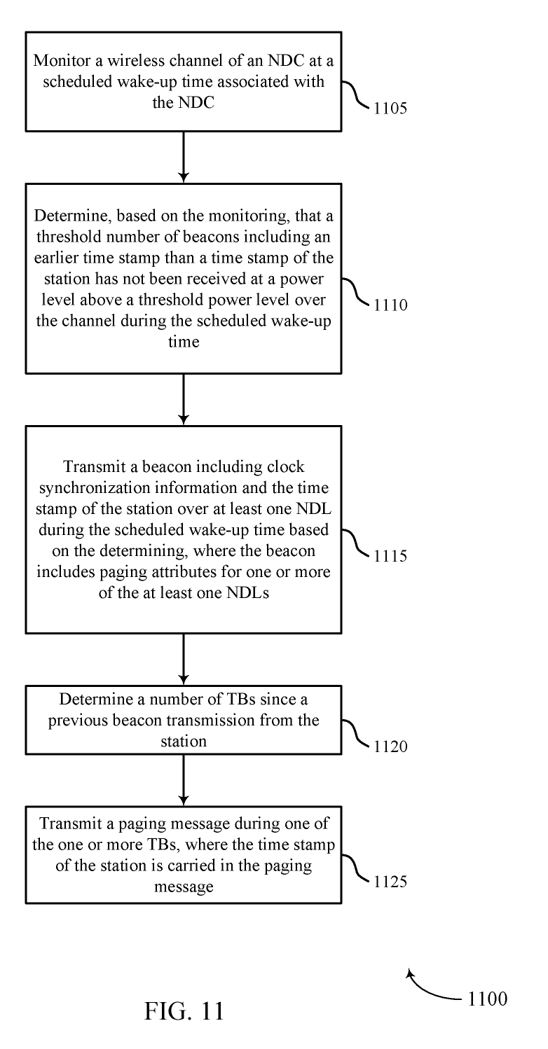

FIG. 11 shows a flowchart illustrating a method 1100 for synchronization techniques for NDLs in accordance with aspects of the present disclosure. The operations of method 1100 may be implemented by a STA 115 or its components as described herein. For example, the operations of method 1100 may be performed by a communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At 1105 the STA 115 may monitor a wireless channel of an NDC at a scheduled wake-up time associated with the NDC. The operations of 1105 may be performed according to the methods described herein. In certain examples, aspects of the operations of 1105 may be performed by an NDC schedule manager as described with reference to FIGS. 5 through 8.

At 1110 the STA 115 may determine, based at least in part on the monitoring, that a threshold number of beacons including an earlier time stamp than a time stamp of the station has not been received at a power level above a threshold power level over the channel during the scheduled wake-up time. The operations of 1110 may be performed according to the methods described herein. In certain examples, aspects of the operations of 1110 may be performed by a clock synchronization manager as described with reference to FIGS. 5 through 8.

At 1115 the STA 115 may transmit a beacon including clock synchronization information and the time stamp of the station over at least one NDL during the scheduled wake-up time based at least in part on the determining, where the beacon includes paging attributes for one or more of the at least one NDLs. The operations of 1115 may be performed according to the methods described herein. In certain examples, aspects of the operations of 1115 may be performed by a beacon manager as described with reference to FIGS. 5 through 8.

At 1120 the STA 115 may determine a number of TBs since a previous beacon transmission from the station. The operations of 1120 may be performed according to the methods described herein. In certain examples, aspects of the operations of 1120 may be performed by a beacon manager as described with reference to FIGS. 5 through 8.

At 1125 the STA 115 may transmit a paging message during one of the one or more TBs, where the time stamp of the station is carried in the paging message. The operations of 1125 may be performed according to the methods described herein. In certain examples, aspects of the operations of 1125 may be performed by a paging manager as described with reference to FIGS. 5 through 8.

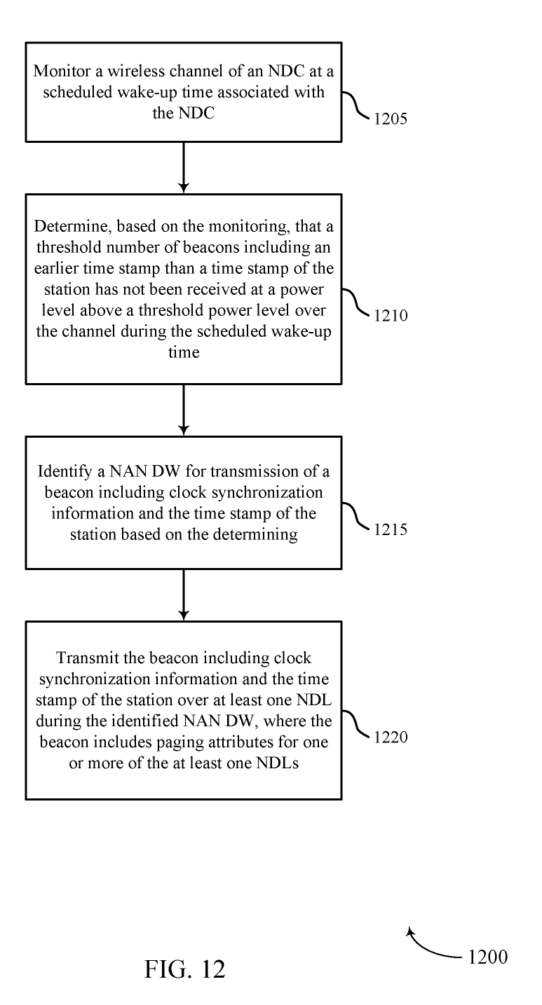

FIG. 12 shows a flowchart illustrating a method 1200 for synchronization techniques for NDLs in accordance with aspects of the present disclosure. The operations of method 1200 may be implemented by a STA 115 or its components as described herein. For example, the operations of method 1200 may be performed by a communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At 1205 the STA 115 may monitor a wireless channel of an NDC at a scheduled wake-up time associated with the NDC. The operations of 1205 may be performed according to the methods described herein. In certain examples, aspects of the operations of 1205 may be performed by an NDC schedule manager as described with reference to FIGS. 5 through 8.

At 1210 the STA 115 may determine, based at least in part on the monitoring, that a threshold number of beacons including an earlier time stamp than a time stamp of the station has not been received at a power level above a threshold power level over the channel during the scheduled wake-up time. The operations of 1210 may be performed according to the methods described herein. In certain examples, aspects of the operations of 1210 may be performed by a clock synchronization manager as described with reference to FIGS. 5 through 8.

At 1215 the STA 115 may identify a NAN DW for transmission of a beacon including clock synchronization information and the time stamp of the station based at least in part on the determining. The operations of 1215 may be performed according to the methods described herein. In certain examples, aspects of the operations of 1215 may be performed by a beacon manager as described with reference to FIGS. 5 through 8.

At 1220 the STA 115 may transmit the beacon including clock synchronization information and the time stamp of the station over at least one NDL during the identified NAN DW, where the beacon includes paging attributes for one or more of the at least one NDLs. The operations of 1220 may be performed according to the methods described herein. In certain examples, aspects of the operations of 1220 may be performed by a beacon manager as described with reference to FIGS. 5 through 8.

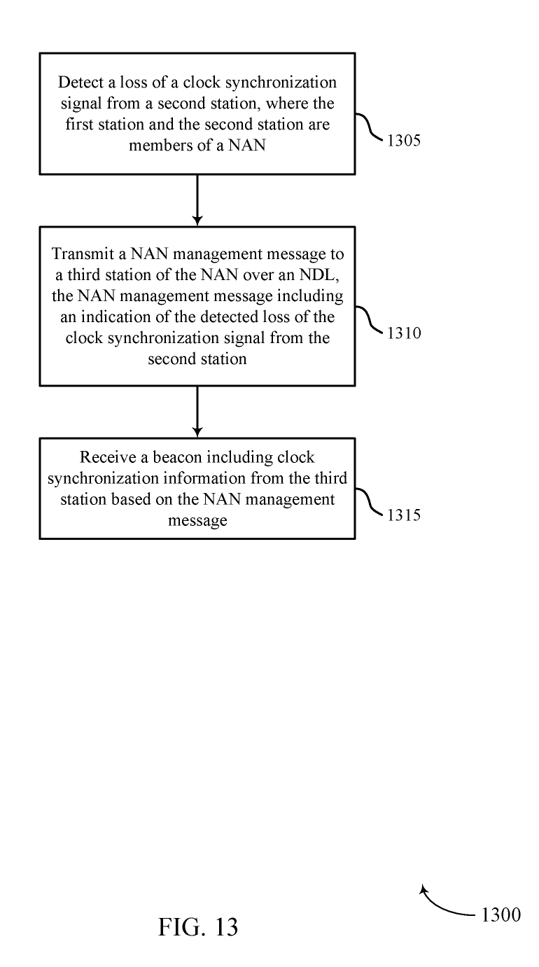

FIG. 13 shows a flowchart illustrating a method 1300 for synchronization techniques for NDLs in accordance with aspects of the present disclosure. The operations of method 1300 may be implemented by a STA 115 or its components as described herein. For example, the operations of method 1300 may be performed by a communications manager as described with reference to FIGS. 5 through 8. In some examples, a STA 115 may execute a set of codes to control the functional elements of the device to perform the functions described below. Additionally or alternatively, the STA 115 may perform aspects of the functions described below using special-purpose hardware.

At 1305 the STA 115 may detect a loss of a clock synchronization signal from a second station, where the first station and the second station are members of a NAN. The operations of 1305 may be performed according to the methods described herein. In certain examples, aspects of the operations of 1305 may be performed by a clock synchronization manager as described with reference to FIGS. 5 through 8.

At 1310 the STA 115 may transmit a NAN management message to a third station of the NAN over an NDL, the NAN management message including an indication of the detected loss of the clock synchronization signal from the second station. The operations of 1310 may be performed according to the methods described herein. In certain examples, aspects of the operations of 1310 may be performed by an NMF manager as described with reference to FIGS. 5 through 8.

At 1315 the STA 115 may receive a beacon including clock synchronization information from the third station based at least in part on the NAN management message. The operations of 1315 may be performed according to the methods described herein. In certain examples, aspects of the operations of 1315 may be performed by a beacon manager as described with reference to FIGS. 5 through 8.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and WLAN 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a station, comprising:
monitoring a wireless channel of a neighbor awareness network (NAN) data cluster (NDC) at a scheduled wake-up time associated with the NDC;
determining, based at least in part on the monitoring, that a threshold number of beacons comprising an earlier time stamp than a time stamp of the station has not been received at a power level above a threshold power level over the channel during the scheduled wake-up time; and
transmitting a beacon comprising clock synchronization information and the time stamp of the station over at least one NAN device link (NDL) during the scheduled wake-up time based at least in part on the determining.

2. The method of claim 1, further comprising:
receiving a second beacon comprising an earlier time stamp than the time stamp of the station; and
suspending beacon transmissions by the station based at least in part on the received second beacon.

3. The method of claim 1, further comprising:
receiving, from a second station, the clock synchronization information during a NAN discovery window (DW);
determining a wait time duration from the scheduled wake-up time, wherein the wait time duration is determined based at least in part on a time duration since the clock synchronization information was received; and
transmitting the beacon comprising clock synchronization information and the time stamp of the station after the determined wait time.

4. The method of claim 1, further comprising:
determining a probabilistic transmission parameter based at least in part on a number of NDLs associated with the station; and
transmitting the beacon comprising clock synchronization information and the time stamp of the station according to the determined probabilistic transmission parameter.

5. The method of claim 1, further comprising:
determining a number of time blocks (TBs) since a previous beacon transmission from the station; and
transmitting the beacon comprising clock synchronization information and the time stamp of the station based at least in part on the determination.

6. The method of claim 1, further comprising:
identifying a NAN discovery window (DW) for transmission of the beacon comprising clock synchronization information and the time stamp of the station based at least in part on the determining; and
transmitting the beacon comprising clock synchronization information and the time stamp of the station over at least one NDL during the identified NAN DW, wherein the beacon includes paging attributes for one or more of the at least one NDLs.

7. The method of claim 6, wherein the NAN DW is identified via a random selection.

8. The method of claim 1, wherein the threshold number of beacons is one beacon.

9. The method of claim 1, wherein the threshold power level is based at least in part on a minimum power level for reception.

10. The method of claim 1, further comprising:
identifying that no beacons have been received based at least in part on the power level indicating no-power or an absence of any measurable power; and
determining to switch from the monitoring based at least in part on the identification, wherein the beacon is transmitted based at least in part on the determination.

11. A method for wireless communication at a first station, comprising:
detecting a loss of a clock synchronization signal from a second station, wherein the first station and the second station are members of a neighbor awareness network (NAN);
transmitting a NAN management message to a third station of the NAN over a NAN device link (NDL), the NAN management message comprising an indication of the detected loss of the clock synchronization signal from the second station; and
receiving a beacon comprising clock synchronization information from the third station based at least in part on the NAN management message.

12. The method of claim 11, wherein transmitting the NAN management message to the third station of the NAN comprises:
transmitting the NAN management message to a plurality of stations of the NAN, the plurality of stations comprising the third station.

13. The method of claim 12, wherein receiving the beacon comprising clock synchronization information from the third station comprises:
receiving a plurality of beacons from the plurality of stations of the NAN in response to the NAN management message; and
selecting one of the plurality of stations as a new source of clock synchronization information for the first station based at least in part on the plurality of beacons.

14. The method of claim 13, wherein the new source of clock synchronization information is a station other than the third station, the method further comprising:
transmitting a second NAN management message to the third station over the NDL based at least in part on the selection of the one of the plurality of stations as the new source of clock synchronization information, the second NAN management message comprising a request to suspend beacon transmission.

15. The method of claim 11, further comprising:
detecting a new beacon transmission from the second station; and
transmitting a second NAN management message to the third station over the NDL based at least in part on the new beacon transmission from the second station, the second NAN management message comprising a request to suspend beacon transmission.

16. The method of claim 11, wherein the NAN management message is transmitted during a time duration consisting of one of a NAN discovery window (DW), a NAN further availability window (FAW), and an NDL time block (TB).

17. A wireless device, comprising:
a wireless modem, wherein the wireless modem is configured to:
perform a monitoring procedure of a wireless channel of a neighbor awareness network (NAN) data cluster (NDC) at a scheduled wake-up time associated with the NDC;
determine, based at least in part on the monitoring, that a threshold number of beacons comprising an earlier time stamp than a time stamp of the wireless device has not been received at a power level above a threshold power level over the channel during the scheduled wake-up time; and
provide for transmission, a beacon comprising clock synchronization information and the time stamp of the wireless device over at least one NAN device link (NDL) during the scheduled wake-up time based at least in part on the determining.

18. The wireless device of claim 17, wherein the wireless modem is further configured to:
obtain a second beacon comprising an earlier time stamp than the time stamp of the wireless device; and
suspend beacon transmissions by the wireless device based at least in part on the received second beacon.

19. The wireless device of claim 17, wherein the wireless modem is further configured to:
obtain the clock synchronization information during a NAN discovery window (DW);
determine a wait time duration from the scheduled wake-up time, wherein the wait time duration is determined based at least in part on a time duration since the clock synchronization information was received; and
provide for transmission, the beacon comprising clock synchronization information and the time stamp of the wireless device after the determined wait time.

20. The wireless device of claim 17, wherein the wireless modem is further configured to:
determine a probabilistic transmission parameter based at least in part on a number of NDLs associated with the wireless device; and
provide for transmission, the beacon comprising clock synchronization information and the time stamp of the wireless device according to the determined probabilistic transmission parameter.

21. The wireless device of claim 17, wherein the wireless modem is further configured to:
determine a number of time blocks (TBs) since a previous beacon transmission from the wireless device; and
provide for transmission, the beacon comprising clock synchronization information and the time stamp of the wireless device based at least in part on the determination.

22. The wireless device of claim 17, wherein the wireless modem is further configured to:
identify a NAN discovery window (DW) for transmission of a beacon comprising clock synchronization information and the time stamp of the wireless device based at least in part on the determining; and
provide for transmission, the beacon comprising clock synchronization information and the time stamp of the wireless device over at least one NAN device link (NDL) during the identified NAN DW, wherein the beacon includes paging attributes for one or more of the at least one NDLs.

23. The wireless device of claim 22, wherein the NAN DW is identified via a random selection.

24. The wireless device of claim 17, wherein the threshold number of beacons is one beacon.

25. The wireless device of claim 17, wherein the threshold power level is based at least in part on a minimum power level for reception.

26. The wireless device of claim 17, wherein the wireless modem is further configured to:
identify that no beacons have been received based at least in part on the power level indicating no-power or an absence of any measurable power; and
determine to switch from the monitoring based at least in part on the identification, wherein the beacon is transmitted based at least in part on the determination.

27. A wireless device, comprising:
a wireless modem, wherein the wireless modem is configured to:
identify a loss of a clock synchronization with a second wireless device, wherein the wireless device and the second wireless device are members of a neighbor awareness network (NAN);
provide for transmission, a NAN management message for a third wireless device of the NAN over a NAN device link (NDL), the NAN management message comprising an indication of the detected loss of the clock synchronization signal from the second wireless device; and
obtain a beacon comprising clock synchronization information from the third wireless device based at least in part on the NAN management message.

28. The wireless device of claim 27, wherein the configuration of the wireless modem to provide the NAN management message for transmission comprises a configuration to:
provide for transmission, the NAN management message for a plurality of wireless devices of the NAN, the plurality of wireless devices comprising the third wireless device.

29. The wireless device of claim 28, wherein the configuration of the wireless modem to obtain the beacon comprising clock synchronization information comprises a configuration to:
obtain a plurality of beacons from the plurality of wireless devices of the NAN in response to the NAN management message; and
select one of the plurality of wireless devices as a new source of clock synchronization information for the wireless device based at least in part on the plurality of beacons.

30. The wireless device of claim 29, wherein the new source of clock synchronization information is from a wireless device other than the third wireless device, and wherein the wireless modem is further configured to:
provide for transmission, a second NAN management message for the third wireless device over the NDL based at least in part on the selection of the one of the plurality of wireless devices as the new source of clock synchronization information, the second NAN management message comprising a request to suspend beacon transmission.
